(19) United States
(12) Patent Application Publication
(10) Pub. No.: US 2004/0224284 A1
(43) Pub. Date: Nov. 11, 2004

(54) Prosthesis like an artificial tooth for bridges

(75) Inventors: Sueo Saito, Tokyo (JP); Tetsuro Sakuma, Tokyo (JP); Futoshi Fusejima, Tokyo (JP); Toshihiro Sekiguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: GC Corporation, Tokyo (JP)

(21) Appl. No.: 10/832,301

(22) Filed: Apr. 27, 2004

(30) Foreign Application Priority Data
May 9, 2003 (JP) 2003-131435

(51) Int. Cl. A61C 13/12

(52) U.S. Cl. 433/202.1; 433/191

(57) ABSTRACT

To provide a prosthesis like an artificial tooth capable of forming the bridge directly and having abrasion resistance and aesthetic equivalent to or more than those of a conventional artificial tooth in a short time and without cutting proximal teeth, said prosthesis is made of a resin material and comprises one tooth or teeth connected two to four teeth, which are approximating to the teeth at the oral cavity side from a mucous of a dental cervix part, and recessed parts are formed at proximal surfaces of its both sides, and further, a part where some at the labial surface side is deleted in the thickness almost corresponding to the thickness of an enamel in a natural tooth and a part where some at the occlusal surface side is deleted in the thickness almost corresponding to the thickness of an enamel in a natural tooth, may be formed.

### BACKGROUND OF THE INVENTION

Field of the Invention

The present invention relates to a prosthesis like an artificial tooth for a bridge, which has abrasion resistance and aesthetic appreciation equivalent to or more than those of a conventional artificial tooth, wherein the bridge can be directly formed in a short time by adhering with proximal teeth with an adhesive material made of a resin without cutting the proximal teeth.

Conventionally, in the case that the tooth is lost in the state where the proximal teeth exist at its both sides but its dental root does not exist, such a treating method has been carried out that a dental prosthesis modeled on a tooth form, which is called as the bridge, is made outside an oral cavity and fixed at the treating part through the support of the proximal teeth of the patient. As the method for fixing the bridge, the following treating methods have been widely carried out, that is, the method of cutting the proximal teeth and fitting a retaining equipment having resiliency, which is called as a clasp and attached to the dental prosthesis, to the proximal teeth, and the method of adhering and fixing the bridge at an abutment tooth formed by widely cutting the proximal teeth. At this time, in the case of requiring the aesthetic appreciation approximating to the natural tooth, the bridge, such as a resin faced bridge, a porcelain baked bridge, an all ceramics bridge or the like, has been used.

In such the conventional treating method called as the bridge, it is necessary to cut some parts of the proximal teeth even if they are healthy teeth, thus the burden on the patient was large.

Especially, in the case of the above-mentioned latter method of adhering and fixing the dental prosthesis at the proximal teeth, which has been carried out most in general, an operator needs to cut the proximal teeth with a turbine to make a form approximating to a head-cut conical form, before making such the dental prosthesis called as the bridge, in order to use the proximal teeth having the almost perfect form as the anchor. Since the abutment tooth is the part to which the dental prosthesis is to be adhered and fixed directly, the operation for forming said abutment tooth should be carefully carried out while considering the form and structure of the dental prosthesis being made after, thus the skill and time were required in said operation.

After forming the abutment tooth in this way, the images of the part including said abutment tooth (a negative mold of the teeth) are obtained from the inside of the oral cavity of the patient, and further, a gypsum model (a reproduction of the teeth) is made with said images. Then, the dental prosthesis is made by the following process, based on said gypsum model.

In the cases of the resin faced bridge and the porcelain baked bridge, these bridges are made by a lost wax casting method, that is, making a wax pattern of a core part on the gypsum model by using a wax, investing the wax pattern in a refractory investment material, taking the refractory investment material into an electric furnace after hardening of said refractory investment material, burning the wax pattern by heating to obtain the mold, casting a metal to the obtained mold, digging up the cast product from the refractory investment material, cutting and polishing said cast product to make a metal core part, and building up and polymerizing a hard resin for a crown or building up and baking a porcelain material on the outer surface of the metal core part. Further, in the case of the all ceramics bridge, said bridge is made by making a double model with using a refractory modeling material, building up and baking the porcelain material on said double model, removing thereafter a refractory double model and carrying out a shape modification and polishing.

As for the work for making the dental prosthesis, the form in the oral cavity and making part are different by every patient, and said work is the complicated work in which the very high dimensional accuracy in several μm unit is required, thus the time and skill were needed so much. That is, since a treatment period until the dental prosthesis being finally fixed in the oral cavity of the patient is long, a patient was forced to bear a high cost and a burden. Further, the making work of the dental prosthesis is carried out by an indirect method, that is, the dental prosthesis is made in a dental laboratory works or the like, which is different from the treating place carrying out the treatment, such as a dental clinic or the like, thus it was the actual condition that the dental prosthesis having perfect accuracy is hardly obtained even when it is made by the expert. Further, since the dental prosthesis is made by the indirect method, there is a problem that the color tone of the made dental prosthesis does not suit completely with that of the proximal teeth, or the like.

Then, the present invention has the object to solve the conventional problems and to provide the prosthesis like an artificial tooth for a bridge capable of forming the dental prosthesis having the same color tone as that of the proximal teeth in a short time only in the treating place, without cutting the healthy proximal teeth, without carefully forming the abutment tooth while considering the form and structure of the dental prosthesis being made after as in conventional case, without making the gypsum model obtained by images, and without indirectly making the dental prosthesis outside the oral cavity, in the case that a tooth is lost in the state where the tooth root does not exist.

### SUMMARY OF THE INVENTION

The earnest work has been carried out in order to solve the above-mentioned problems and, as the result, the following fact was found out to complete the present invention about the prosthesis like an artificial tooth for a bridge. That is, in the prosthesis, which is made of a resin material and has a form as an artificial tooth approximating to a tooth being at the oral cavity side from a mucous of a dental cervix part, and the recessed parts are formed at proximal surfaces of its both sides, when a photopolymerizable or room temperature polymerizable adhesive material made with the resin, such as a low viscosity dental composite resin or the like, is applied to said recessed parts to adhere and fix with the proximal surfaces, the bridge can be made in a short time only in the treating place without cutting the healthy proximal teeth to carefully form the abutment tooth while considering the form and structure of the dental prosthesis being made after as in conventional case, without making the gypsum model obtained by images, and without indirectly making the dental prosthesis outside the oral cavity.

That is, the present invention relates to the prosthesis like an artificial tooth for a bridge, wherein said prosthesis is made of a resin material and has a form as an artificial tooth approximating to a tooth being at the oral cavity side from a mucous of a dental cervix part and recessed parts are formed at the proximal surfaces of its both sides. Further, the present invention also relates to the prosthesis like an artificial tooth for a bridge, which is suitable in making the bridge for two or more of teeth, wherein said prosthesis is made of a resin material, two to four teeth having forms approximating to teeth being at the oral cavity side from a mucous of a dental cervix part are connected, and recessed parts are formed at the proximal surfaces of its both sides.

Moreover, it was also found out that, when a part where some at the labial surface side is deleted in the thickness almost corresponding to the thickness of an enamel in a natural tooth is formed, it is preferable from aesthetic point since the color tone can be adjusted with the proximal natural teeth. Further, when a part where some at the occlusal surface side is deleted in the thickness almost corresponding to the thickness of an enamel in a natural tooth is formed, it is preferable from aesthetic point since the color tone can be adjusted with the proximal natural teeth, and it is also preferable since the ideal occusal surface, which is most suitable for the patient, can be made.

### BRIEF EXPLANATION OF DRAWINGS

Hereinafter, the prosthesis like an artificial tooth for a bridge according to the present invention will be explained concretely with reference to drawings.

FIG. 1 is a perspective view of an example of the prosthesis like an artificial tooth for a bridge according to the present invention, which is used for a molar.

FIG. 2 is a plane view of FIG. 1.

FIG. 3 is a plane view of an example of the prosthesis like an artificial tooth for a bridge according to the present invention, which is used for a premolar.

FIG. 4 is a perspective view of an example of the prosthesis like an artificial tooth for a bridge according to the present invention, which is used for a anterior tooth.

FIG. 5 is a perspective view of another example of the prosthesis like an artificial tooth for a bridge according to the present invention, which is used for the premolar.

FIG. 6 is a perspective view of another example of the prosthesis like an artificial tooth for a bridge according to the present invention, which is used for the premolar.

FIG. 7 is a perspective view of the still another example of the prosthesis like an artificial tooth for a bridge according to the present invention, which is used for the anterior tooth.

FIG. 8 is a perspective view of an example of the prosthesis like an artificial tooth for a bridge according to the present invention, in which two teeth are connected.

### DETAILED DESCRIPTION OF PREFERRED EMBODIMENT

In drawings, 1 is the prosthesis like an artificial tooth for a bridge according to the present invention, which is made of the resin material. The resin material generally comprises a polymer being a mixture of a polymerizable compound having an unsaturated double bond and a polymerization catalyst, and further, a filler may be taken in said material. Although the conventional material for an artificial tooth can be used without limitation, when the filler is taken in the resin material, said resin material is the same material as the conventional dental resin material called as hard resin, thus the conventional characteristics of a hard resin tooth, that is, high abrasion resistance and aesthetic appreciation can be obtained.

More particularly, the resin material for making the prosthesis like an artificial tooth for a bridge 1 according to the present invention is the dental resin material, in which a filler, such as glass powder, aerosil or the like, is contained in a polymerizable monomer being generally called as composite resin or hard resin. The resin material has the approximating color tone to that of the tooth, thus when an excess is generated at the time of adhering, said resin material can be used by removing the excess easily or grinding it after the polymerization. Further, said resin material may be an adhesive dental resin material including an adhesive monomer or a resin material for building up the abutment tooth according to the necessity.

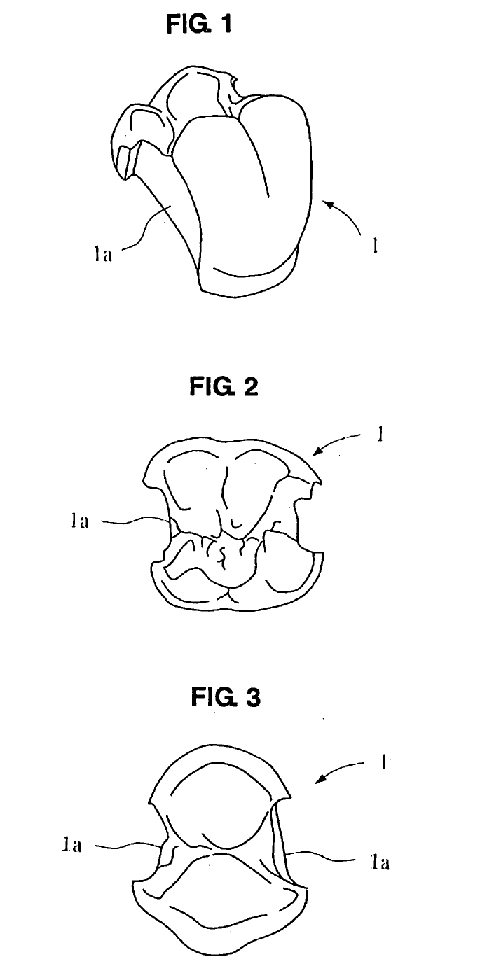

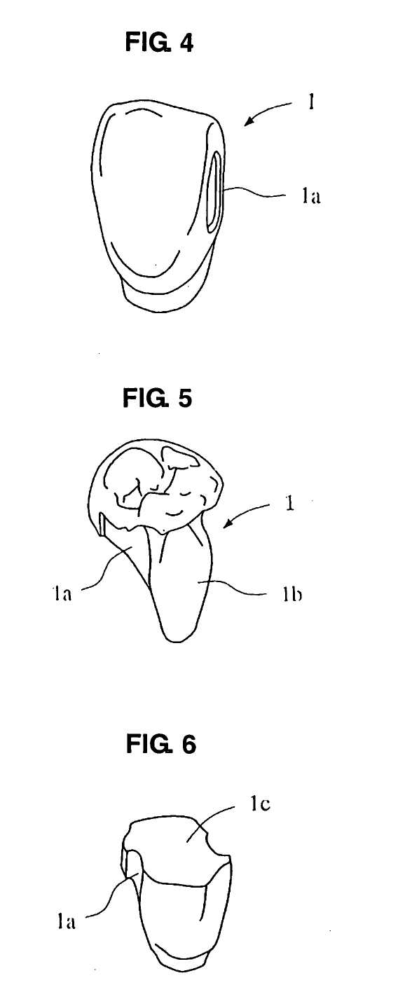

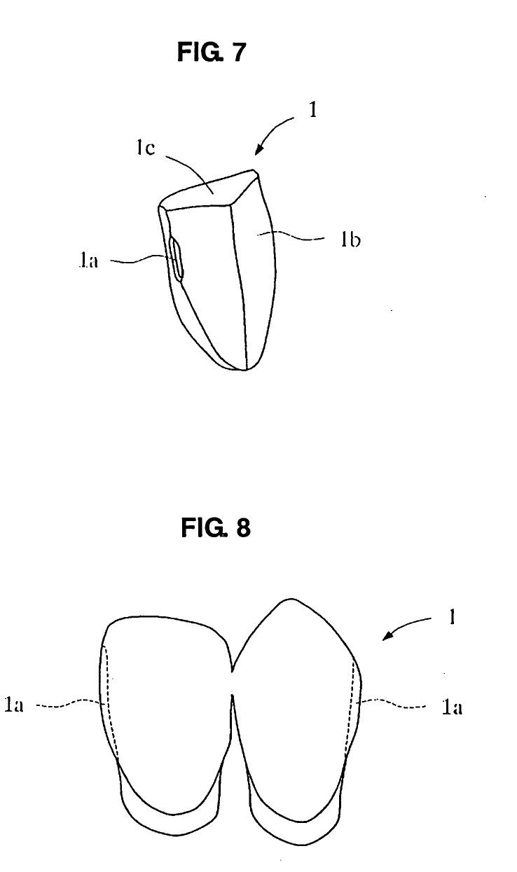

The prosthesis like an artificial tooth for a bridge 1 according to the present invention is characterized by having the form approximating to the tooth being at the oral cavity side from a mucous of a dental cervix part and having recessed parts 1a formed at the proximal surfaces of its both sides to adhere said prosthesis with the proximal teeth by using a resin material. Said prosthesis is certainly adhered with the proximal teeth with a photopolymerizable or room temperature polymerizable adhesive material made with the resin, which is applied to said recessed parts 1a, and is fixed as the bridge. As the shape of said prosthesis, for example, there are the following various shapes, that is, the shape for a molar as shown in FIGS. 1 and 2, the shape for a premolar as shown in FIGS. 3, 5 and 6, the shape for an anterior tooth as shown in FIGS. 4 and 7, and the shape in which two to four teeth are connected as shown in FIG. 8. In the case of the shape in which two to four teeth are connected as shown in FIG. 8, the recessed parts 1a are formed at the proximal surfaces of its both ends.

In these various shapes, when the shape is made such that the recessed parts 1a are formed at the proximal surfaces and a part 1b where some at the labial surface side (the buccal surface side when the object tooth is molars) is deleted in the thickness almost corresponding to the thickness of an enamel in a natural tooth is formed as shown in FIG. 5, the color tone of the prosthesis like an artificial tooth for a bridge can be easily made to fit with that of the proximal teeth, by making the labial surface side of said prosthesis with a resin material, such as composite resin or the like. As for the work for making the labial surface side of the proximal teeth of the prosthesis like an artificial tooth for a bridge, there is an advantage that the amount of the built resin material is small since said material is built only by the thickness almost corresponding to the thickness of an enamel in a natural tooth.

Further, when the shape is made such that the recessed parts 1a are formed at the proximal surfaces and a part 1c where some at the occlusal surface side (the cutting edge side when the object tooth is the anterior tooth) is deleted in the thickness almost corresponding to the thickness of an enamel in a natural tooth is formed as shown in FIG. 6, there is an advantage that the color tone of the prosthesis like an artificial tooth for a bridge can be easily made to fit with that of the proximal teeth, by making the occlusal surface side of said prosthesis with a resin material, such as composite resin or the like, as mentioned above. In addition, the thickness at the occlusal surface side can be proximal to obtain the ideal occlusion. As for the work for making the occlusal surface side of the proximal teeth of the prosthesis like an artificial tooth for a bridge, there is an advantage that the amount of the built resin material is small since said material is built only by the thickness almost corresponding to the thickness of an enamel in a natural tooth.

Further, the shape may be made such that the recessed parts 1a are formed at the proximal surfaces, the part 1b where some at the labial surface side (the buccal surface side when the object tooth is molars) is deleted in the thickness almost corresponding to the thickness of an enamel in a natural tooth is formed, and a part 1c where some at the cutting edge side (the occlusal surface side when the object tooth is molars) is deleted in the thickness almost corresponding to the thickness of an enamel in a natural tooth is formed.

For using such the prosthesis like an artificial tooth for a bridge 1 according to the present invention, the prosthesis being suitable to the part, where a tooth is lost in the state of no tooth root existing while the proximal teeth exist, is chosen to be arranged at the oral cavity side from the mucous of the dental cervix part where the tooth is lost, and the prosthesis is adhered to and fixed at the proximal surfaces of the proximal teeth, by applying a resin material, such as dental composite resin or the like, to the recessed parts 1a formed at the proximal surfaces. In this case, it is preferable to apply composite resin having a low viscosity composition as compared with composite resin used for filling a tooth. By these works carried out only in the oral cavity directly, the bridge having the form of anterior tooth, caninetooth, molars or plural teeth including these teeth can be made.

Further, when the prosthesis like an artificial tooth for a bridge 1 according to the present invention has the shapes, in which the part 1b where some at the labial surface side (the buccal surface side when the object tooth is molars) is deleted in the thickness almost corresponding to the thickness of an enamel in a natural tooth is formed, and the part 1c where some at the occlusal surface side (the cutting edge side when the object tooth is the anterior tooth) is deleted in the thickness almost corresponding to the thickness of an enamel in a natural tooth is formed, the color tone of the prosthesis like an artificial tooth for a bridge may be adjusted or the occlusal surface side may be adjusted to obtain the ideal occlusion, by making the labial surface side or the occlusal side of the prosthesis with a resin material such as composite resin or the like.

When the prosthesis like an artificial tooth for a bridge 1 according to the present invention is used in this way, the dental prosthesis can be made in a short time only in the treating place, without carefully making the abutment tooth such as a abutment tooth or the like while considering the form and structure of the dental prosthesis being made after as in conventional case, and also without the indirect works, such as making the gypsum model obtained by images, or making the bridge outside the oral cavity.

As mentioned above, as for the prosthesis like an artificial tooth for a bridge according to the present invention, when making of the dental prosthesis is necessary since the tooth is lost in the state of no tooth root existing, a dental prosthesis having the same color tone as that of the proximal teeth can be made in a short time only in the treating place, wherein cutting of a healthy tooth and careful making of the abutment tooth while considering the form and structure of the dental prosthesis being made after as in conventional case is not necessary, thus a burden on the patient can be reduced to a minimum, and further, making of the gypsum model obtained by images and indirectly making of the dental prosthesis outside the oral cavity are not necessary. Therefore, said prosthesis has the great value for contributing to the dental treatment.

What is claimed is:

1. A prosthesis like an artificial tooth for a bridge (1),
wherein said prosthesis is made of a resin material and has a form approximating to a tooth being at the oral cavity side from a mucous of a dental cervix part, and recessed parts (1a) are formed at proximal surfaces of its both sides.

2. A prosthesis like an artificial tooth for a bridge (1),
wherein said prosthesis is made of the resin material, two to four teeth having forms approximating to teeth being at the oral cavity side from a mucous of a dental cervix part are connected, and recessed parts (1a) are formed at the proximal surfaces of its both sides.

3. The prosthesis like an artificial tooth for a bridge (1) according to claim 1 or claim 2,
wherein a part (1b) where some at the labial surface side is deleted in the thickness almost corresponding to the thickness of an enamel in a natural tooth is formed.

4. The prosthesis like an artificial tooth for a bridge (1) according to any one of claim 1 to claim 3,
wherein a part (1c) where some at the occlusal surface side is deleted in the thickness almost corresponding to the thickness of an enamel in a natural tooth is formed.
